(19) United States
(12) Patent Application Publication
(10) Pub. No.: US 2015/0166027 A1
(43) Pub. Date: Jun. 18, 2015

(54) HYDRAULIC BRAKE SYSTEM

(71) Applicant: MANDO CORPORATION, Pyeongtaek-si (KR)

(72) Inventors: Sang-Soo Han, Seongnamsi (KR); Chun-Sic Yun, Yongin-si (KR)

(21) Appl. No.: 14/308,486

(22) Filed: Jun. 18, 2014

(30) Foreign Application Priority Data
Dec. 18, 2013 (KR) 10-2013-0158203

(51) Int. Cl. B60T 13/14; B60T 13/68

(52) U.S. Cl. CPC B60T 13/141; B60T 13/686

(57) ABSTRACT

Disclosed herein is a hydraulic brake system. According to an embodiment of the present invention, a hydraulic brake system having a hydraulic block in which first and second hydraulic circuits for respectively controlling an oil pressure transmitted to two wheels are formed includes first and second inlet flow paths through which an oil pressure discharged from a pump disposed in a main flow path of each of the hydraulic circuits flows in and first and second outlet flow paths through which the flowing-in oil pressure is discharged are formed in the hydraulic block, and a pressure buffer device that is mounted in a flow path of the hydraulic block connecting the main flow path of each of the hydraulic circuits to thereby damp the oil pressure discharged from each pump, wherein the pressure buffer device includes a check valve that communicates with the inlet and outlet flow paths of each of the hydraulic circuits and prevents the oil pressure from flowing back from the outlet flow path.

### CROSS-REFERENCE TO RELATED APPLICATION

This application claims the benefit of Korean Patent Application No. P2013-0158203, filed on Dec. 18, 2013 in the Korean Intellectual Property Office, the disclosure of which is incorporated herein by reference.

### BACKGROUND

1. Field

Embodiments of the present invention relate to a hydraulic brake system, and more particularly, to a hydraulic brake system which includes a pressure buffer device so as to increase a brake oil pressure supplied to a wheel cylinder in braking and minimize pressure pulsation.

2. Description of the Related Art

A hydraulic brake system for braking is necessarily mounted in a vehicle, but in recent years, several types of systems for obtaining much stronger and more stable braking force have been proposed. As examples of the hydraulic brake system, an Anti-lock Brake System (ABS) that prevents slip of wheels in braking, a Brake Traction Control System (BTCS) that prevents slip of driving wheels in rapid starting of the vehicle or in rapid acceleration thereof, a Vehicle Dynamic Control System (VDC) that stably maintains the traveling state of the vehicle by combining the ABS and the BTCS to control a brake oil pressure, and the like are given.

Such a hydraulic brake system includes a master cylinder for generating a pressure required for braking, a plurality of solenoid valves for controlling a braking hydraulic pressure transmitted to the side of a wheel brake provided in each wheel of the vehicle, a low pressure accumulator for temporarily storing oil, a pump and a motor for forcibly pumping the oil temporarily stored in the low pressure accumulator, an orifice for reducing pressure pulsation of the oil pumped by the pump, an Electronic Control Unit (ECU) for electrically controlling driving of the solenoid valves and the pump, and the like. A valve assembly of the solenoid valves, the accumulator, the pump, the motor, and the like are compactly provided in a hydraulic block (modulator block) made of aluminum, and the ECU includes an ECU housing with a coil assembly of the solenoid valves and a circuit board built therein so that the ECU housing is coupled to the hydraulic block.

Such a hydraulic brake system includes two hydraulic circuits for respectively controlling two wheels to thereby control a hydraulic pressure provided to each wheel.

However, sudden pressure pulsation that occurs by pump driving while increasing a braking pressure is reduced by the orifice provided in the discharge port side of the pump, but this is achieved in a structure of adjusting a cross-sectional area of a flow path in order to simply reduce damping, and therefore there is a limitation in completely reducing the pressure pulsation.

In addition, as another method for reducing the pressure pulsation, the number of pistons of the pump may be increased, but this increases overall performance of the motor, overall weight and volume of modules, and the like, resulting in an increase in manufacturing costs. When a peak of the pressure pulsation by pump driving continuously occurs, this may cause occurrence of operation noise of the brake system.

In order to solve such problem, a pressure buffer device for reducing the pressure pulsation is provided in a flow path connecting two hydraulic circuits.

The pressure buffer device connects the outlet side of the pump provided in each hydraulic circuit to each other to thereby damp an oil pressure discharged from the pump. In this instance, as shown in FIGS. 1 and 2, the pressure buffer device has one piston 2 at a center thereof and springs 3 at both ends thereof, and therefore the pressure pulsation is reduced while the piston 2 is moved to both sides in accordance with an oil pressure.

Specifically, the pressure buffer device 1 includes two oil pressure holes 4 provided in both sides of a housing 5 with the piston 2 built therein and the two oil pressure holes 4 are connected to a main flow path 7a of each of hydraulic circuits 6A and 6B. Here, when the oil pressure is transmitted to any one of the oil pressure holes 4, the pressure pulsation may be reduced by pushing the piston 2.

In addition, in order to prevent the backflow of the oil pressure discharged through the oil pressure holes 4 in accordance with the movement of the piston 2, a check valve 8 is provided in each main flow path 7a.

However, such a pressure buffer device 1 has a pressure pulsation reduction effect by the piston 2, but has a problem in that the fluidity of oil is reduced when the oil flows into and out of the pressure buffer device 1 via each of the hydraulic circuits 6A and 6B and one main flow path 7a. That is, the oil flows into and out of the pressure buffer device via the main flow path 7a of each of the hydraulic circuits 6A and 6B in directions of arrows A and A′ and arrows B and B′ shown in FIG. 2, and therefore the fluidity of oil is reduced.

Meanwhile, the check valve 8 for preventing the backflow of the oil should be separately provided in the main flow path 7a, and therefore the assembly time and costs are increased and it is difficult to have high design flexibility due to a limited installation space.

### SUMMARY

Therefore, it is an aspect of the present invention to provide a hydraulic brake system having a pressure buffer device, in which inlet and outlet flow paths are separately provided to improve the fluidity of oil while a check valve is provided in the pressure buffer device, and a disposition space is secured to achieve high design flexibility.

Additional aspects of the invention will be set forth in part in the description which follows and, in part, will be obvious from the description, or may be learned by practice of the invention.

In accordance with one aspect of the present invention, a hydraulic brake system having a hydraulic block in which first and second hydraulic circuits for respectively controlling an oil pressure transmitted to two wheels are formed, includes: first and second inlet flow paths through which an oil pressure discharged from a pump disposed in a main flow path of each of the hydraulic circuits flows in and first and second outlet flow paths through which the flowing-in oil pressure is discharged are formed in the hydraulic block; and a pressure buffer device that is mounted in a flow path of the hydraulic block connecting the main flow path of each of the hydraulic circuits to thereby damp the oil pressure discharged from each pump, wherein the pressure buffer device includes a check valve that communicates with the inlet and outlet flow paths of each of the hydraulic circuits and prevents the oil pressure from flowing back from the outlet flow path.

Here, the pressure buffer device may include a housing that communicates with the inlet and outlet flow paths of each of the hydraulic circuits and includes an opened one side, a piston that is reciprocatingly movably provided inside the housing and partitions the inside of the housing into first and second damping chambers, a plug member that is coupled to the opened one side of the housing and in which a connection flow path communicating with any one damping chamber of the first and second damping chambers is formed, and an elastic member that is provided in each of the first and second damping chambers to elastically support a reciprocating movement of the piston, and wherein the check valve is disposed inside the housing to prevent oil from flowing back through the outlet flow path.

Also, a first inlet hole and a first outlet hole respectively communicating with the first inlet flow path and the first outlet flow path through the first damping chamber may be formed on the other side of the housing, a second inlet hole communicating with the second inlet flow path through the second damping chamber may be formed on the one side of the housing, and the second outlet flow path may communicate with the connection flow path formed in the plug member.

Also, the check valve may be mounted in each of the first outlet hole and the connection flow path.

Also, a sealing member for preventing oil flow between the two damping chambers may be provided on an outer peripheral surface of the piston.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a schematic cross-sectional view showing a conventional pressure buffer device;

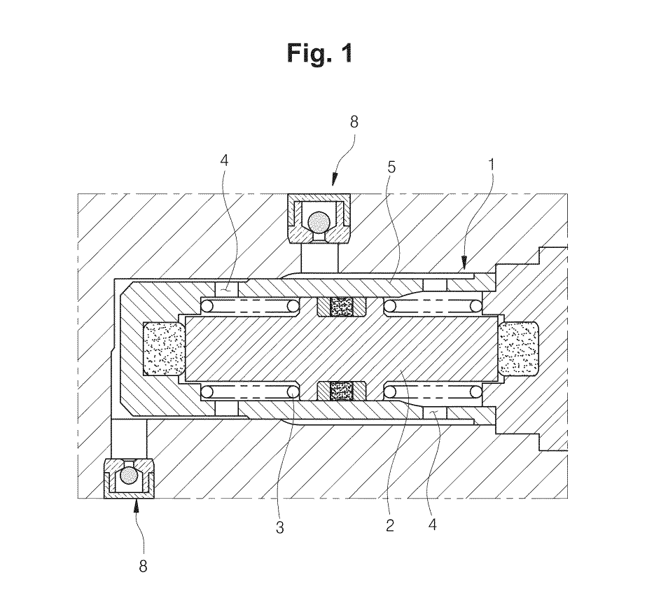

FIG. 2 is a schematic view showing a conventional hydraulic brake system;

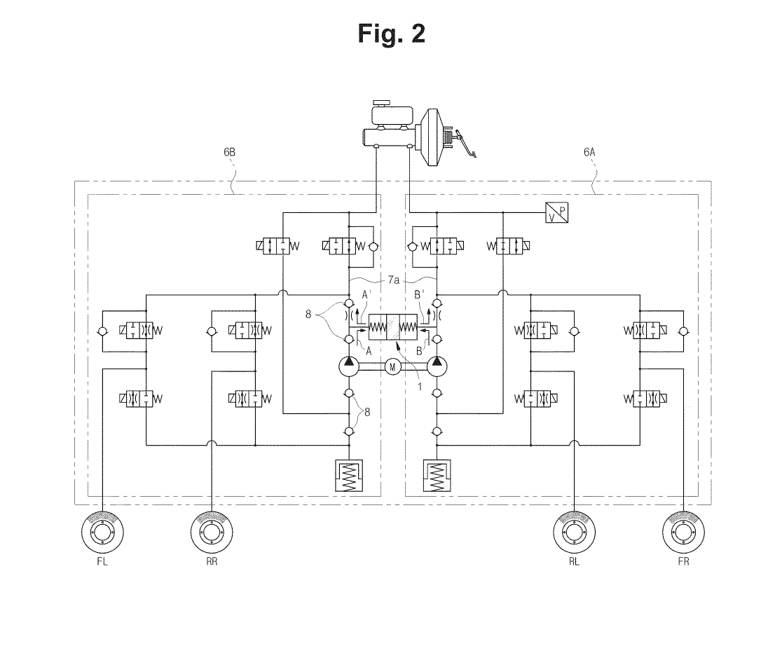

FIG. 3 is a view showing a hydraulic brake system in which a pressure buffer device according to an embodiment of the present invention is provided; and

FIG. 4 is a cross-sectional view showing a main part of a pressure buffer device provided in a hydraulic brake system according to an embodiment of the present invention.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

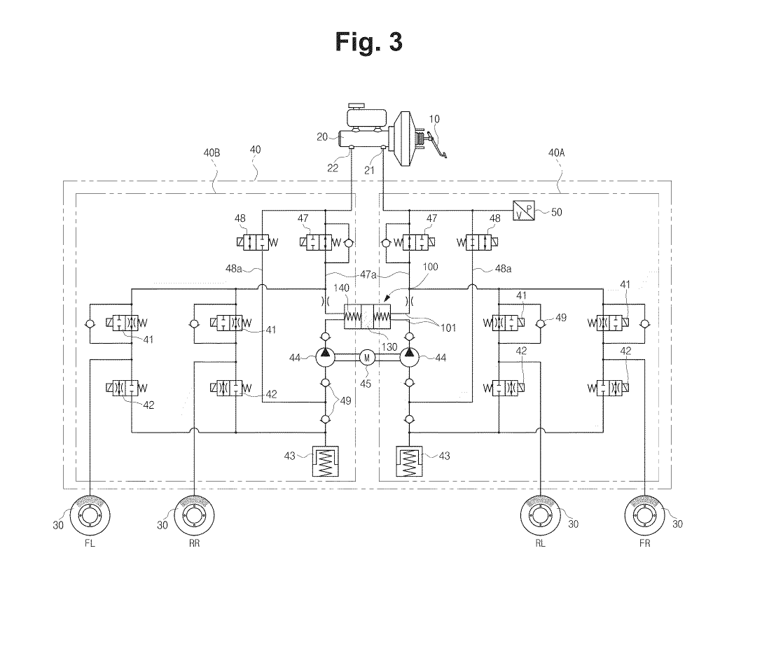

FIG. 3 is a view showing a hydraulic brake system in which a pressure buffer device according to an embodiment of the present invention is provided.

Referring to FIG. 3, the hydraulic brake system includes a brake pedal 10 that accepts an operating force of a driver, a brake booster 11 that doubles a pedal effort of the brake pedal 10 using a pressure difference between atmospheric pressure and vacuum pressure by the pedal effort of the brake pedal 10, a master cylinder 20 that generates a pressure by the brake booster 11, a first hydraulic circuit 40A that connects a first port 21 of the master cylinder 20 and a wheel cylinder 30 provided in two wheels FR and RL to control oil pressure transmission, and a second hydraulic circuit 40B that connects a second port 22 of the master cylinder 20 and a wheel cylinder 30 provided in the remaining two wheels FL and RR to control oil pressure transmission. The first hydraulic circuit 40A and the second hydraulic circuit 40B are provided in a hydraulic block 40 in a compact manner.

The first hydraulic circuit 40A and the second hydraulic circuit 40B respectively include solenoid valves 41 and 42 for controlling a brake oil pressure transmitted to the two wheel cylinders 30, a pump 44 that sucks oil flowing out of the wheel cylinder 30 or oil from the master cylinder 20 by driving of a motor 45 and pumps the sucked oil, a low pressure accumulator 43 that temporarily stores the oil flowing out of the wheel cylinder 30, a main flow path 47a that connects a discharge port of the pump 44 and the master cylinder 20, an auxiliary flow path 48a that guides the oil of the master cylinder 20 to be sucked into an entrance of the pump 44, a plurality of solenoid valves 41 and 42, and an Electronic Control Unit (ECU; not shown) for controlling driving of the plurality of solenoid valves 41 and 42 and the motor 45.

In this instance, as shown in FIG. 3, the solenoid valves 41 and 42, the low pressure accumulator 43, the pump 44, the main flow path 47a, and the auxiliary flow path 48a are provided in the first and second hydraulic circuits 40A and 40B, respectively.

More specifically, the plurality of solenoid valves 41 and 42 are in conjunction with the upstream side and downstream side of the wheel cylinder 30, and are classified into a normal open type solenoid valve 41 that is disposed on the upstream side of each wheel cylinder 30 and usually maintained at an opened state and a normal close type solenoid valve 42 that is disposed on the downstream side of each wheel cylinder 30 and usually maintained at a closed state. Opening and closing operations of such solenoid valves 41 and 42 may be controlled by the ECU (not shown). Specifically, the normal close type solenoid valve 42 is opened in accordance with pressure reducing braking so that oil flowing out of the wheel cylinder 30 side is temporarily stored in the low pressure accumulator 43.

The pump 44 is driven by the motor 45 to suck and discharge the oil stored in the low pressure accumulator 43, thereby transmitting an oil pressure to the wheel cylinder 30 side or the master cylinder 20 side.

In addition, in the main flow path 47a connecting the master cylinder 20 and the discharge port of the pump 44, the normal open type solenoid valve 47 (hereinafter, referred to as TC valve) for controlling a traction control system (TCS) is provided. The TC valve 47 is usually maintained at an opened state, and transmits the brake oil pressure formed in the master cylinder 20 to the wheel cylinder 30 side via the main flow path 47a at a general brake time through the brake pedal 10.

In addition, the auxiliary flow path 48a branches from the main flow path 47a to guide the oil of the master cylinder 20 to be sucked into the entrance side of the pump 44, and a shuttle valve 48 for allowing the oil to flow only to the entrance of the pump 44 is provided in the auxiliary flow path 48a. The shuttle valve 48 that is electrically operated is provided in the middle of the auxiliary flow path 48a, and usually closed but opened in a TCS mode.

Meanwhile, a reference numeral ‘49’ which is not described is a check valve that is provided in an appropriate position of the flow path in order to prevent the flow of an opposite direction of the oil, and a reference numeral ‘50’ is a pressure sensor that detects a braking pressure transmitted to the TC valve 47 and the shuttle valve 48.

In the above-described hydraulic brake system, pressure pulsation is generated from the oil pressure that is pumped from the pump 44 in response to the operation of the motor 45 at a brake time. Here, according to an embodiment of the present invention, a pressure buffer device 100 that is provided in a flow path 101 connecting the two hydraulic circuits 40A and 40B in order to reduce the pressure pulsation is provided.

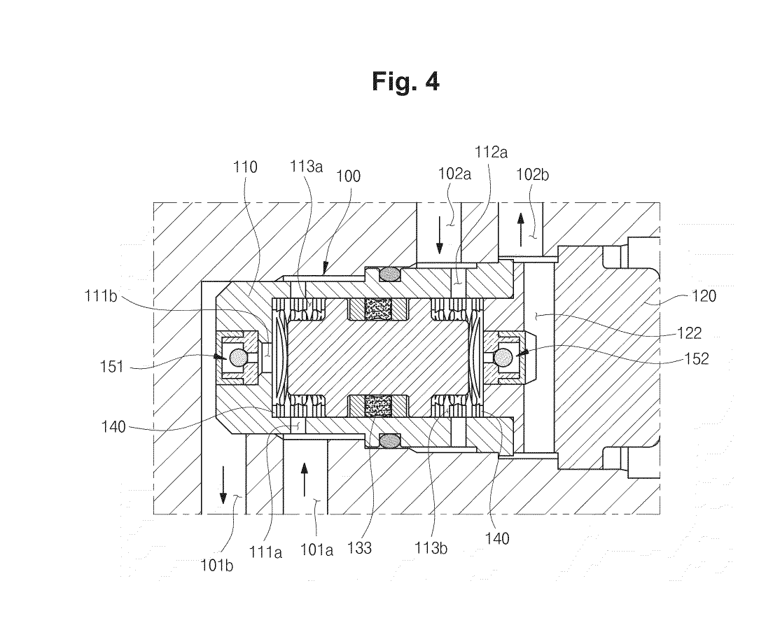

FIG. 4 is a cross-sectional view showing a main part of a pressure buffer device provided in a hydraulic brake system according to an embodiment of the present invention.

Referring to FIGS. 3 and 4, the pressure buffer device 100 according to an embodiment of the present invention includes a cylindrical housing 110 that is fixed in a flow path of the hydraulic block 40 so as to connect the first and second hydraulic circuits 40A and 40B and has an opened one side, a piston 130 that is reciprocatingly movably provided inside the housing 110, a plug member 120 that is coupled to the opened one side of the housing 110, an elastic member 140 that is provided on both sides of the piston 130 to provide an elastic force to the piston 130, and check valves 151 and 152 which are disposed inside the housing 110.

Meanwhile, in the flow path formed in the hydraulic block 40, first and second inlet flow paths 101a and 102a through which an oil pressure discharged from the pump 44 disposed in the main flow path 47a flows in and first and second outlet flow paths 101b and 102b through which the flowing-in oil pressure is discharged are formed. Thus, the pressure buffer device 100 communicates with the inlet flow paths 101a and 102a and the outlet flow paths 101b and 102b of the hydraulic circuits 40A and 40B.

The housing 110 is fitted into the flow path connecting the discharge port sides of the two pumps 44 to be fixed. The housing 110 is formed into a cylindrical shape with an opened one side, and the plug member 120 is coupled to the opened one side so that the housing 110 is closed. In addition, the inside of the housing 110 is partitioned into a first damping chamber 113a and a second damping chamber 113b by the piston 130 that is reciprocatingly movably provided. That is, the first damping chamber 113a is provided between an inner wall of the other side of the housing 110 and the piston 130 and the second damping chamber 113b is provided between the plug member 120 and the piston 130.

In the housing 110, a plurality of holes communicating with the main flow path 47a of the first and second hydraulic circuits 40A and 40B are formed. For example, a first inlet hole 111a communicating with the first inlet flow path 101a, a first outlet hole 111b communicating with the first outlet flow path 101b, and a second inlet hole 112a communicating with the second inlet flow path 102a are formed in the housing 110. In this instance, the second outlet flow path 102b communicates with a connection flow path 122 formed in the plug member 120. As shown in FIG. 4, the first inlet hole 111a and the first outlet hole 111b are formed on the other side of the housing 110 to communicate with the first inlet flow path 101a and the first outlet flow path 101b through the first damping chamber 113a, respectively. The second inlet hole 112a communicates with the second inlet flow path 102a through the second damping chamber 113b, and the connection flow path 122 communicates with the second outlet flow path 102b through the second damping chamber 113b. Thus, the oil pressure discharged from the pump 44 via each of the inlet holes 111a and 112a is transmitted to the damping chambers 113a and 113b inside the housing 110, and the oil pressure discharged to the first and second outlet flow paths 101b and 102b via the outlet hole 111b and the connection flow path 122 is transmitted to the main flow path 47a. In this instance, a flow state of the oil pressure will be described again later.

As described above, the piston 130 is reciprocatingly movably provided inside the housing 110, and partitions the inside of the housing 110 into the first and second damping chambers 113a and 113b. A sealing member 133 for preventing oil flow between the two damping chambers 113a and 113b is provided on an outer peripheral surface of the piston 130.

The elastic member 140 is provided in each of the damping chambers 113a and 113b to provide an elastic force to the piston 130. The elastic member 140 is constituted of a coil spring which is typically used, but the elastic member 140 according to an embodiment of the present invention is constituted of a wave spring. When the elastic member 140 is constituted of the wave spring, it is possible to reduce the whole length of the pressure buffer device 100, and improve a pressure damping effect due to large accumulated energy (elastic restoring force) per unit area compared to the coil spring.

The check valves 151 and 152 are disposed inside the housing so as to prevent oil from flowing back via the outlet flow paths 101a and 102b. As shown in FIG. 4, the check valves 151 and 152 include the first check valve 151 mounted in the first outlet hole 111b communicating with the first outlet flow path 101b and the second check valve 152 mounted in the connection flow path 122 of the plug member 120 communicating with the second outlet flow path 102b. The first and second check valves 151 and 152 are respectively mounted in the housing 110 and the plug member 120, and therefore may be assembled together when assembling the pressure buffer device 100, thereby reducing assembly costs.

Hereinafter, a state of attenuating pressure pulsation at a braking action time of the hydraulic brake system according to an embodiment of the present invention configured as above will be described.

First, a driver decelerates a vehicle while the vehicle is traveling or at halt, or depresses the brake pedal 10 in order to maintain a halt state. Thus, boosting power amplified than an input is generated in the brake booster 11, and therefore a brake oil pressure of a considerable pressure is generated in the master cylinder 20. Such a brake oil pressure is transmitted to each of wheels FR, FL, RR, and RL through the solenoid valve 41, whereby a braking action is performed. When the driver gradually or completely takes his or her foot off the brake pedal 10, the oil pressure inside each wheel cylinder 30 returns again to the master cylinder 20 through the solenoid valve 42, whereby the braking force is reduced or the braking action is completed released.

Meanwhile, pressure pulsation of a regular half sine wave is generated in the hydraulic brake system due to a pair of pumps 44 which are driven while having a phase difference of 180 degrees by a single driving motor 45 at a braking operation time, but the generated pressure pulsation is attenuated by the pressure buffer device 100.

For example, when the oil pressure discharged via the discharge port of the pump 44 is transmitted to the first inlet hole 111a via the first inlet flow path 101a, the piston 130 moves in an opposite direction of a direction in which the oil pressure is transmitted, that is, moves to the second damping chamber 113b. That is, the pressure pulsation is attenuated while a shock is absorbed by the elastic member 140. In addition, the oil pressure of the second damping chamber 113b which is pressed by the piston 130 flows to the second outlet flow path 102b via the connection flow path 122 of the plug member 120. Similarly, when the oil pressure is transmitted to the second inlet hole 112a via the second inlet flow path 102a, the piston 130 moves to the first damping chamber 113a side to attenuate the pressure pulsation, and the oil pressure of the first damping chamber 113a is discharged to the first outlet flow path 101b through the first outlet hole 111b. In this instance, the discharged oil pressure is prevented from flowing back by the check valves 151 and 152 provided in the first outlet hole 111b and the connection flow path 122. In addition, as the oil pressure separately flows via the inlet flow paths 101a and 102a and the outlet flow paths 101b and 102b, the fluidity of the oil pressure is more improved compared to the related art in which the oil pressure flows in and out via a single flow path.

Meanwhile, a case in which the pressure buffer device 100 according to an embodiment of the present invention is provided and pairs of inlet flow paths 101a and 102a and outlet flow paths 101b and 102b are provided to secure the fluidity of the oil pressure is shown, but the present invention is not limited thereto. For example, it should be understood that the first and second check valves 151 and 152 provided in the pressure buffer device 100 are selectively provided so that the flow directions of the first and second check valves 151 and 152 can be changed, whereby flow design of the inlet flow paths and the outlet flow paths can be freely changed.

As is apparent from the above description, in the hydraulic brake system according to the embodiment of the present invention, the pressure buffer device is provided in the flow path connecting the two hydraulic circuits, thereby increasing the brake oil pressure supplied to the wheel cylinder and minimizing the pressure pulsation.

In addition, the inlet flow path through which oil flows into the pressure buffer device and the outlet flow path through which oil flows out of the pressure buffer device are separately provided, thereby improving the fluidity of the oil.

In addition, the check valve for preventing the backflow of the oil pressure discharged into the pressure buffer device is provided, thereby securing the disposition space to have high design flexibility, and reducing the assembly costs.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A hydraulic brake system having a hydraulic block in which first and second hydraulic circuits for respectively controlling an oil pressure transmitted to two wheels are formed, the hydraulic brake system comprising:
first and second inlet flow paths through which an oil pressure discharged from a pump disposed in a main flow path of each of the hydraulic circuits flows in and first and second outlet flow paths through which the flowing-in oil pressure is discharged are formed in the hydraulic block; and
a pressure buffer device that is mounted in a flow path of the hydraulic block connecting the main flow path of each of the hydraulic circuits to thereby damp the oil pressure discharged from each pump,
wherein the pressure buffer device includes a check valve that communicates with the inlet and outlet flow paths of each of the hydraulic circuits and prevents the oil pressure from flowing back from the outlet flow path.

2. The hydraulic brake system according to claim 1, wherein the pressure buffer device includes
a housing that communicates with the inlet and outlet flow paths of each of the hydraulic circuits and includes an opened one side,
a piston that is reciprocatingly movably provided inside the housing and partitions the inside of the housing into first and second damping chambers,
a plug member that is coupled to the opened one side of the housing and in which a connection flow path communicating with any one damping chamber of the first and second damping chambers is formed, and
an elastic member that is provided in each of the first and second damping chambers to elastically support a reciprocating movement of the piston, and
wherein the check valve is disposed inside the housing to prevent oil from flowing back through the outlet flow path.

3. The hydraulic brake system according to claim 2, wherein
a first inlet hole and a first outlet hole respectively communicating with the first inlet flow path and the first outlet flow path through the first damping chamber are formed on the other side of the housing,
a second inlet hole communicating with the second inlet flow path through the second damping chamber is formed on the one side of the housing, and
the second outlet flow path communicates with the connection flow path formed in the plug member.

4. The hydraulic brake system according to claim 3, wherein the check valve is mounted in each of the first outlet hole and the connection flow path.

5. The hydraulic brake system according to claim 2, wherein a sealing member for preventing oil flow between the two damping chambers is provided on an outer peripheral surface of the piston.
